(19) United States
(12) Patent Application Publication
(10) Pub. No.: US 2011/0185490 A1
(43) Pub. Date: Aug. 4, 2011

(54) Folding Bedside Commode

(76) Inventor: Jean Bonamy, Miami Shores, FL (US)

(21) Appl. No.: 12/696,855

(22) Filed: Jan. 29, 2010

(51) Int. Cl. A61G 9/00; A61G 7/02; A47K 11/04

(52) U.S. Cl. 4/452; 4/480; 4/483

(57) ABSTRACT

A portable bedside commode is provided with safety features that include arm rests that independently swing or rotate out of the way, a hooking means on either side of the commode to attach it to a more stable structure such as a bed frame and legs of adjustable height so that the hooks are at the appropriate height and the height of the seat is at the appropriate height, for example at the same height as a bed so that a user of the device may more easily transfer from a prone position in bed onto the commode. Another important feature is a seat alarm that is triggered on at a threshold weight and then sounds an alarm if the user of the commode has been on it for a predetermined length of time and therefore likely in need of attention. In a preferred embodiment the commode is also collapsible for storage or transport.

### BACKGROUND OF THE INVENTION

1. Field of the Invention

The present invention relates to commodes, and more particularly, to a commode with improved safety and convenience features.

2. Description of the Related Art

Several designs for commodes have been designed in the past. None of them, however, includes, among other things, an alarm that notifies others if the user of the commode has been left on the commode too long without assistance and a collapsible and removable receptacle

Applicant believes that the closest reference corresponds to U.S. Pat. No. 6,941,591 issued to Battiston. However, it differs from the present invention because the present invention includes a means to temporarily attach the commode to a bed frame or other immobile object to provide additional stability and therefore safety. Furthermore, the present invention includes a replaceable and collapsible receptacle for waste so that the device is more sanitary and can be reused for subsequent users of the device. Furthermore, the present invention can be easily folded down for transport or storage and when in use is sturdily held open by gravity. In the present invention the more weight that is on the commode, up to a predetermined limit, the more stable it becomes.

Another relevant reference corresponds to U.S. Pat. No. 5,945,914 issued to Holmes. However, it differs from the present invention because the present invention is integral to a portable commode and causes an audible alarm when a person is on the commode for a predetermined time. In contrast Holmes and others provide for an alarm to indicate when a person moves from a toilet, bed or chair and is presumably mobile. Contrarily, the present invention notifies of the lack of movement which may be an indicator that the user of the commode needs attention. The present invention further provides for resetting the alarm when additional time is needed for the user of the commode after the user of the commode has been checked by a caregiver.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a safe and practical bedside commode.

It is a principal objective of the invention to provide a means to notify a caregiver that a person has been on a portable commode for a predetermined length of time.

It is another object of this invention to provide a commode that easily and temporarily attaches to a stable structure such as a bed frame or wall hooks.

It is still another object of the present invention to provide a portable and collapsible commode.

Another object of the instant invention is to provide a more sanitary commode by including a removable and disposable receptacle for human waste.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of a version of the present invention.

FIG. 2 shows a perspective view of a variation of a receptacle assembly in a transport or storage mode.

FIG. 3 illustrates a perspective view of a variation of a receptacle assembly as may be configured for use.

FIG. 4 is a flow chart of an example of the processor logic.

FIG. 5 is a perspective view of an alternate variation of the present invention.

FIG. 6 is a perspective view of a version of the present invention that has been collapsed into a storage and transport mode.

### DETAILED DESCRIPTION OF THE PREFERRED EMBODIMENT

Referring now to the drawings, where the present invention is generally referred to with numeral 10, it can be observed that it basically includes, inter alia, a main frame 12, rear frame 14, arm rest 16, feet 18, shoes 20, seat frame 22, brace 24, brace 26, back 28, hooks 30, sensor 32, cable 34, processor 36, seat 38, receptacle assembly 40 and flange 50.

In a preferred embodiment the main frame 12 is has two ground contacting feet 18 and the rear frame 14 has two ground contacting feet 18. Optionally, each of the feet 18 has a shoe 20 to provide protection to the floor and grip onto the floor.

Brace 24 provides structural rigidity to the main frame 12. Brace 26 lends structural strength to the rear frame 14. In a preferred embodiment the feet 18 are concentrically nested inside the main frame 12 and rear frame 14 so that the height of the seat 38 may be adjusted for the comfort and safety of users of various heights. It may also be desirable to adjust the height of the seat 38 to closely match the height of a bed or chair, for example, to allow easier transfer of a person between that bed or chair and the commode.

The hooks 30 are provided on one or both sides of the rear frame 14 to temporarily attach the bedside commode to a bed, chair or other structure. By hooking the hooks 30 to a stable object the device will not move when transferring a person onto or off of the device thereby increasing the safety of the caregiver and the person using the bedside commode. In a preferred embodiment the elevation of the hooks 30 may be adjustable so that they may more easily engage onto structures (i.e. a bed frame) with varying heights. In another embodiment the hooks 30 are at a fixed height off the floor matching the side rails on a standardized bed frame. The hooks 30 may be slidably attached to the rear frame 14 so that the hook 30 can be slid up or down the rear frame 14 to engage a bed rail or other supporting structure.

The seat frame 22 is rotatably mounted between the main frame 12 on a one edge and rear frame 14 at a second edge. The degree of rotation is permitted to fold the bedside commode for storage or transport by rotating the seat frame 22 up against the back 28 after folding in the arm rests 16 down against the seat frame 22.

The seat frame 22 supports the seat 38. The seat 38 is functionally and dimensionally similar to a common toilet seat. An opening in the middle area of the seat 38 provides a path for any waste to pass through into the receptacle assembly 40. Optionally, the seat 38 is padded to provide enhanced comfort. The seat 38 preferably is made of a smooth material that is hypoallergenic and easily cleanable. Optionally the seat 38 is removable and replaceable. In a preferred embodiment the seat 38 is hinged onto the seat frame 22 to provide better access to the receptacle assembly 40.

Around the inside of the opening of the seat 38 is a flange 50. The receptacle assembly 40 is removably affixed to the seat frame 22 at the flange 50. The flange 50 is preferably made from a rigid material that is easily cleanable.

The processor 36 is located where a caregiver can conveniently see the access the controls on the case of the processor 36. The processor 36 is connected to a sensor 32 that measures the weight applied onto the seat 38 and transmits that information to the processor 36 via a cable 34. It is contemplated that the signal between the processor 36 and the sensor 32 may be transmitted wirelessly or through a safe low voltage current transmitted through the main frame 12 and/or seat frame 22. For some applications it is foreseeable that the processor 36 may be located on other areas of the commode such as, for example, on one of the arm rests 16 so that the user of the commode could reach the controls on the processor 36 to extend the time remaining on the processor 36.

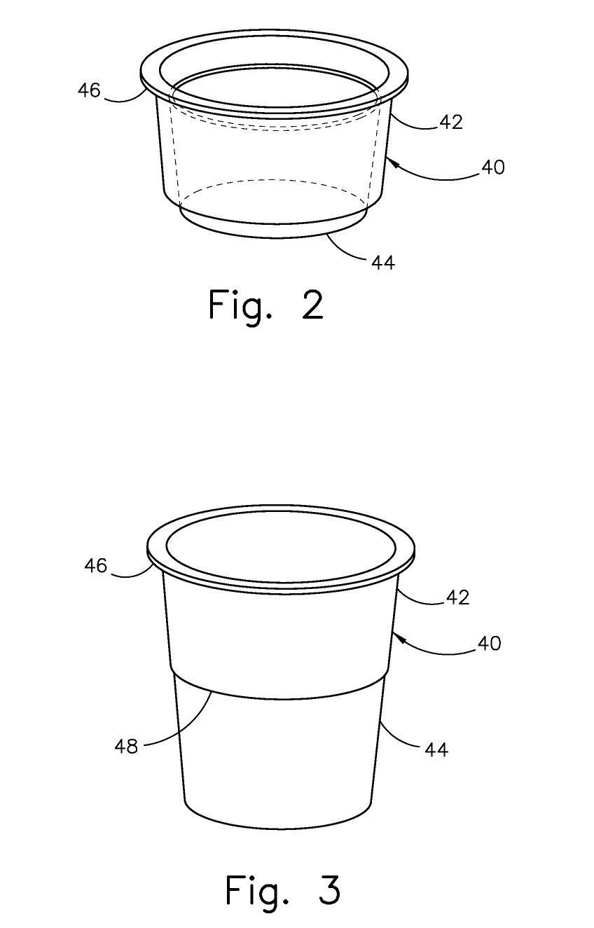

Now referring to FIGS. 2 and 3 where a variation of the receptacle assembly 40 is shown in more detail to include, inter alia, an upper 42, a lower 44, a lip 46 and a seam 48.

As shown in FIG. 2 the receptacle assembly 40 may be collapsed by nesting the lower 44 into the upper 42 to reduce the overall size of the receptacle assembly 40. To achieve the nesting ability the upper edge of the lower 44 must be larger than the lower edge of the upper 42. Other methods commonly available in the art may also be employed to nest the various elements of the receptacle assembly 40 into one another to reduce the overall size. For example, the upper 42 could thread into corresponding threads on the lower 44 to form a watertight seal when in use such as demonstrated in FIG. 3 or collapsed as shown in FIG. 2.

FIG. 3 shows the receptacle assembly 40 as it may be configured in typical use where the lower 44 is extended from inside the upper 42. The lower rim of the upper 42 meets snugly with the upper rim of the lower 44 to for a seam 48. Preferably the seam 48 is watertight and prevents unwanted movement between the upper 42 and lower 44 while retaining the ability to collapse the various elements of the receptacle assembly 40 for storage or transport as demonstrated in FIG. 2 and described above in more detail. The lower 44 is closed on the bottom end to support the contents of the receptacle assembly.

The upper 42 may be used in the commode without the lower 44 element when the commode is placed over a regular toilet. The upper 42 then acts as a chute to direct waste through the upper 42 into the bowl of a toilet. This feature may be useful when the user of the commode desired to use the seat 38 of the commode higher than the seat on a permanently plumbed toilet. A commode used for this purpose may need to remove brace 26 to position the commode over the toilet.

A lip 46 is provided to interface with the flange 50 on the seat frame 22 to hold the receptacle assembly 40 in position under the seat 38. For ease of cleaning the receptacle assembly 40 a liner is preferably used. The liner may also contain a liquid absorbing material, for example, any of the polyacrylate class of liquid absorbers or thickeners such as sodium polyacrylate. Optionally, the liner may have a feature to aid in sealing the liner bag after use such as a plastic zipper or tie-able tabs so that the waste contained therein may be safely and sanitarily transported to a disposal area.

As an alternative to the receptacle assembly 40 shown in FIGS. 2 and 3 is a one piece receptacle. A lip similar to the lip 46 on the receptacle assembly 40 is preferably present to mount the one piece receptacle onto the flange 50 of the seat frame 22.

Not shown in the drawings and preferably present is a handle connected to the upper 42 to aid in removing and cleaning the receptacle assembly 40. When the commode is in use the handle may be rotated out of the way against the flange 46.

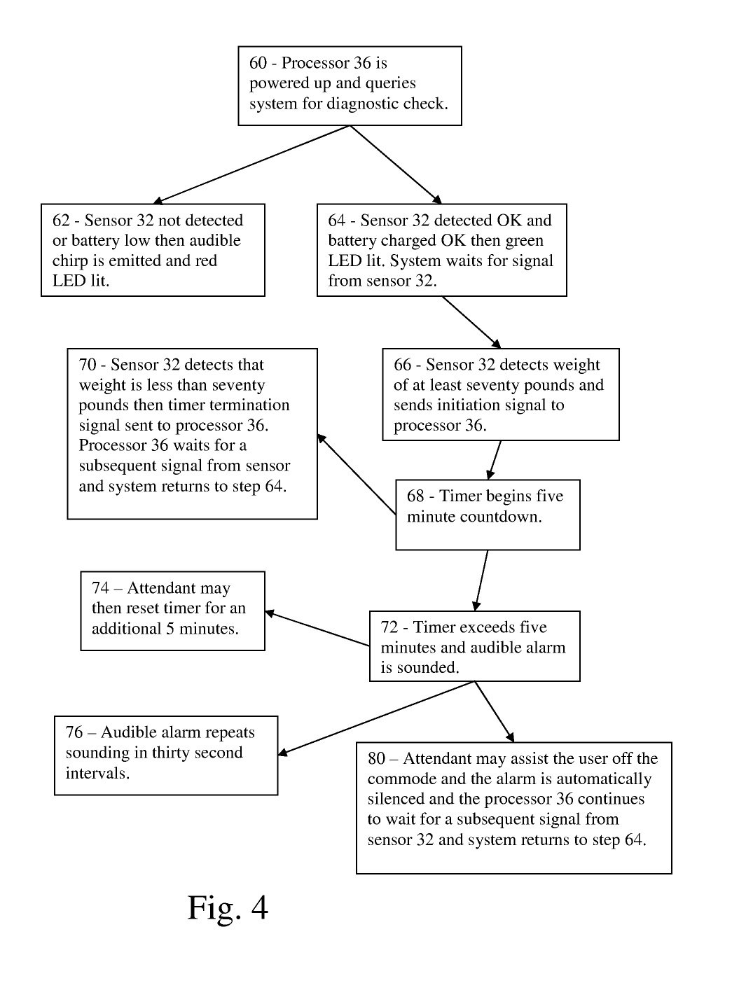

FIG. 4 is an example of the logic circuit of the processor 36 and is intended only as an example of one of many different ways to effect safe monitoring of the commode. In a preferred embodiment the electronic system is comprised of the processor 36, a sensor 32 and cable 34 connecting the processor 36 and sensor 32.

The sensor 32 is configured so that it can detect when weight is placed onto the seat 38. Generally this would require the sensor 32 to be between the seat 38 and seat frame 22.

Still referring to FIG. 4 where in step 60 the processor 36 is powered on by a switch and then initializes with a diagnostic sequence. Typically the processor 36 is battery powered but other available and known means to power the circuit could effectively be employed. The diagnostic sequence checks for the battery (or other power source) sufficiency and for the presence of a functioning sensor.

If for example the sensor 32 is not detected or the power source is low, as in step 62, an audible chirp is sounded and a red LED is lit to indicate to the caregiver that the device is not functioning normally. In that case the battery is replaced and the sensor cable 34 is checked and replaced if necessary.

If the power supply is sufficient and the sensor 32 is detected, as in step 64, a green LED is lit indicating that the system is operating normally and ready for use. When the sensor 32 detects that a weight is on the seat 38 greater than a preset threshold amount a signal is sent via the cable 34 to the processor 36 to initiate a timer sequence as shown in step 68.

The preset threshold weight that triggers the sensor 32 may be effective at about seventy pounds. For example, a typical adult hospital patient weights greater than seventy pounds and would therefore be able to trigger the sensor 32 where a child visitor or an inanimate object placed on the seat 38 would not trigger the sensor 32 thereby reducing the frequency of false alarms. Similarly the threshold weight might be set at thirty pounds for a pediatric application. A switch on the processor 36 may provide a selection between one of several predetermined weight thresholds so that a wide range of users could effectively use the commode while reducing the number of false alarms.

In step 68 once the sensor 32 triggers the processor 36 that the threshold weight has been met the commode is presumably in use and a timer begins to count down. The processor 36 may have a switch for any of several predetermined intervals to count down. For example, three minutes, five minutes and ten minutes. The use of the device could specify what interval is preferred by moving a selector switch on the processor 36 corresponding to that time.

If before the timer runs out the weight is lifted off the sensor 32, and therefore necessarily the seat 38, a signal is sent to the processor 36 as shown in step 70. That signal indicates to the processor 36 to stop the countdown timer and the system reverts to step 64 waiting for another signal from the sensor 32 assuming that the user of the commode has ceased using the commode.

If the timer exceeds the preset time, five minutes in the example shown in step 74 in FIG. 4, then an audible alarm is sounded. The alarm is intended to notify a caregiver that the commode has been in use longer than what was estimated necessary and the user of the commode may need assistance. In many instances a user of the commode needs assistance getting onto the seat 38 and then prefers privacy while using the commode so the caregiver is absent for a period. The alarm then aids the user getting timely help off the commode in step 80 by timely notifying the caregiver that assistance may be necessary.

The audible alarm may be a buzzer, beeps or a pre-recorded voice saying, for example, “Assistance needed . . . assistance needed.” Of course other appropriate recordings could be implemented as well. There may be a visual alarm such as a strobe or flashing light in addition to, or alternate to, the audible alarm.

If the user of the commode exceeds the preset time, five minutes in the example in FIG. 4, the alarm sounds. If the sensor 36 is still indicating that the weight is on the seat 38 after the five minute alarm has sounded a reminder alert may sound and/or light on shorter predetermined intervals, possibly thirty second intervals as shown in step 76.

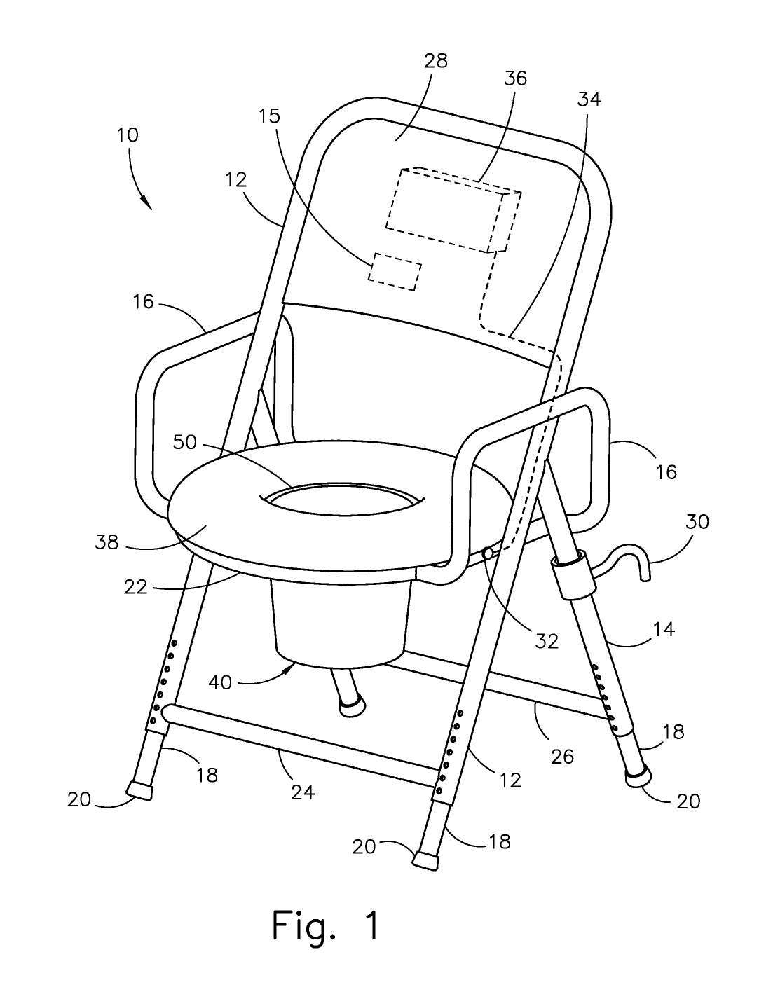

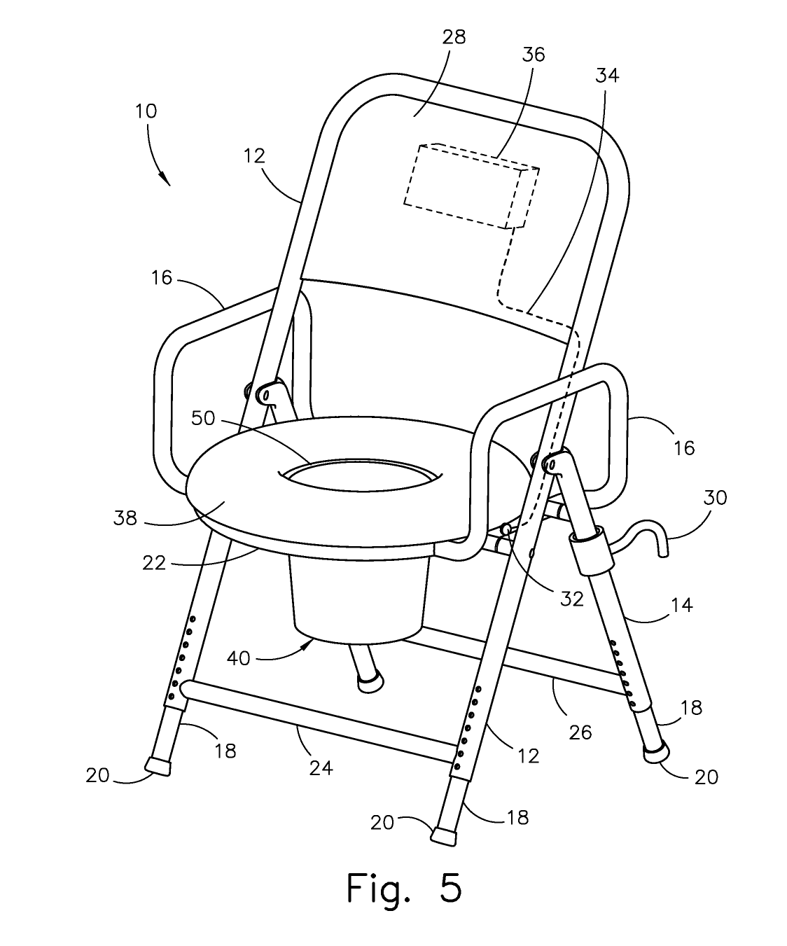

FIG. 5 shows additional optional joint between the main frame 12 and rear frame 14. This hinge means may make the commode fold more compactly. Additionally shown is a clip 15 (shown in FIG. 1 and optional on all variations) on the rear of the back 28 to provide a means to hold either or both of the arm rests 16 when removed from the seat frame 22. Arm rests 16 may be removed to permit side access, for example when a user transfers from a bed to the commode or for transport and storage mode.

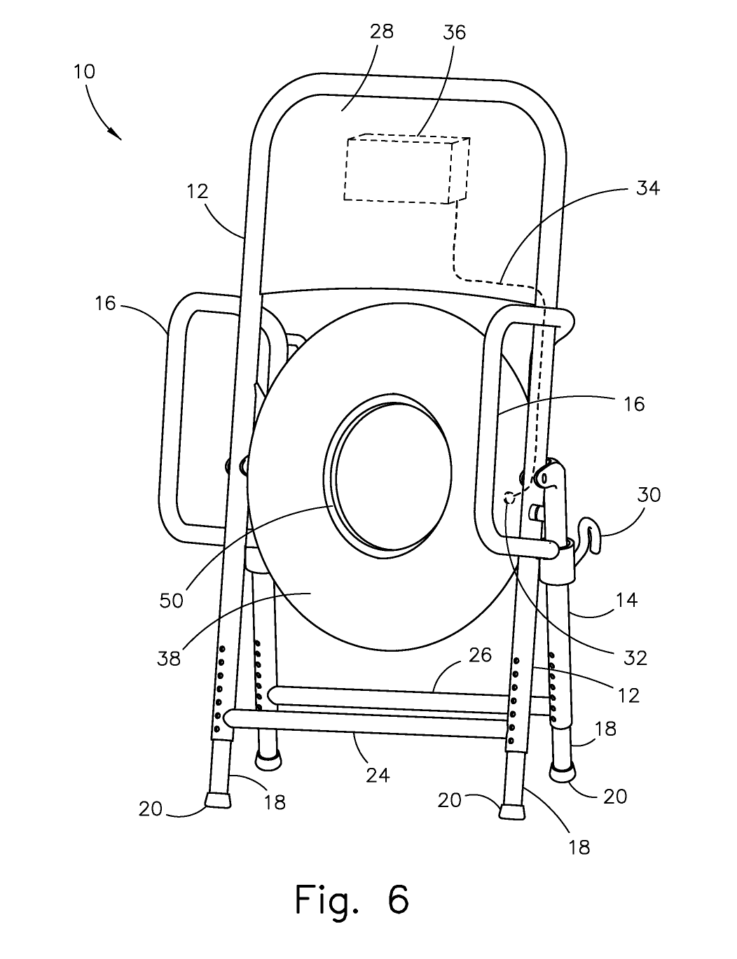

FIG. 6 shows the folding bedside commode in its folded configuration for storage or transport. To make the device as compact as possible the arm rests 16 may be folded against the seat 38. The receptacle assembly 40 has been removed and can be replaced with a new receptacle assembly 40 for a new user to improve sanitation. To further compact the device the rear frame 14 is folded against the main frame 12 and the seat frame 22 and seat 38 are folded against the main frame 12 to results in a compact form.

A variation of the present invention can be described as a portable commode comprising a frame assembly, a receptacle assembly and an alarm assembly where said frame assembly is further comprised of three or four legs, a back and a pair of arm rests where said legs are each telescopically extendable and lockable to a predetermined range of lengths and said frame assembly has an attachment means to removably affix the portable commode to another structure and said frame assembly is collapsible into a more compact form by folding said legs together and/or folding said arm rests against the frame assembly and said receptacle assembly further comprising a seat and a removable receptacle and said receptacle assembly is disposed between said pair of arm rests and supported by the frame assembly and is removably affixed under the seat and said arm rests are independently moveable away from adjacent to said receptacle assembly and also separable from the frame assembly and said seat is dimensioned similar to a toilet seat and having an open area in the center similar to a toilet seat and said alarm assembly having a sensor means to activate the alarm assembly when the sensor detects that a predetermined weight has been applied to the seat; when said alarm assembly is activated a timer set to a predetermined length of time is initiated; when said predetermined length of time is reached an audible and/or visible alert is initiated; if the weight applied to the seat falls below said predetermined weight then said timer is stopped. It can optionally include that said receptacle assembly is provided with a liner and a moisture absorbing solid. It can also optionally include a liner that is self sealable with a plastic zipper. Also it could include wheels provided on the ground contacting lower end of the legs. It could also include a clip that is affixed to the frame assembly or back providing a means to hold one or two arm rests that have been detached from the frame assembly. It could also include a feature that said alarm assembly has a button to delay said alert for a predetermined additional length of time.

Another version of the invention is described as a portable commode comprising a frame assembly, a receptacle assembly and an alarm assembly; said frame assembly is comprised of four legs, two arm rests and a back rest; said receptacle assembly comprised of a seat having a void in the center under which a receptacle is affixed; said frame supporting said receptacle assembly such that a user of the portable commode could comfortably sit on the seat over the receptacle; said arm rests removably affixed to the frame assembly in a position such that a user of the portable commode could comfortably rest their arms on the arm rests; said legs are each independently adjustable to a predetermined range of lengths; said frame assembly having at least one hook positioned so that the portable commode could be removably attached to a stable structure not a part of the portable commode; said receptacle is removable from the frame assembly; said alarm assembly having a sensor capable of sensing when a predetermined weight is on the seat and then said alarm assembly emits an audible and/or visible alarm if the predetermined weight remains on the seat for a predetermined length of time. Optionally it may include features that allow said frame assembly to be collapsible by folding said legs together and folding said armrests against the frame assembly. It may also have wheels at the lower ground contacting portion of the legs and the receptacle may be used with a disposable liner that has an integral zipper closure means and contains a liquid absorbing means. It is also optional that said receptacle has a removable bottom so that the portable commode could be placed over a conventional toilet so that material passed into the receptacle falls into the conventional toilet.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A portable commode comprising a frame assembly, a receptacle assembly and an alarm assembly;
a. Said frame assembly is further comprised of three or four legs, a back and a pair of arm rests;
b. Said legs are each telescopically extendable and lockable to a predetermined range of lengths;
c. Said frame assembly has an attachment means to removably affix the portable commode to a pre-selected bed frame or other pre-selected structure;
d. Said frame assembly is collapsible into a more compact form by folding said legs together and/or folding said arm rests against the frame assembly;
e. Said receptacle assembly further comprising a seat and a removable receptacle;
f. Said receptacle assembly disposed between said pair of arm rests and supported by the frame assembly and is removably affixed under the seat;
g. Said arm rests independently moveable away from adjacent to said receptacle assembly and also separable from the frame assembly;
h. Said seat being dimensioned similar to a toilet seat and having an open area in the center similar to a toilet seat;
i. Said alarm assembly having a sensor means to activate the alarm assembly when the sensor detects that a predetermined weight is applied to the seat; when said alarm assembly is activated a timer set to a predetermined length of time is initiated; when said predetermined length of time is reached an audible and/or visible alert is initiated; if the weight applied to the seat falls below said predetermined weight then said timer is stopped.

2. A portable commode as disclosed in claim 1 further characterized in that said receptacle assembly is provided with a liner and a moisture absorbing material.

3. A portable commode as disclosed in claim 2 further characterized in that said liner is self sealable with a plastic zipper.

4. A portable commode as disclosed in claim 1 further characterized in that a wheel is provided on the lower, ground contacting end of each of the legs.

5. A portable commode as disclosed in claim 1 further characterized in that a clip is affixed to the frame assembly or back providing a means to hold one or two arm rests that have been detached from the frame assembly.

6. A portable commode as disclosed in claim 1 further characterized in that said alarm assembly has a feature to delay said alert for a predetermined additional length of time.

7. A portable commode comprising a frame assembly, a receptacle assembly and an alarm assembly; said frame assembly comprised of four legs, two arm rests and a back rest; said receptacle assembly comprised of a seat having an opening in the center under which a receptacle is affixed; said frame supporting said receptacle assembly such that a user of the portable commode could comfortably sit on the seat over the receptacle; said arm rests removably affixed to the frame assembly in a position such that a user of the portable commode could comfortably rest their arms on the arm rests; said legs are each independently adjustable to a predetermined range of lengths; said frame assembly having at least one hook positioned so that the portable commode could be removably attached to a pre-selected stable structure not a part of the portable commode; said receptacle is removable from the frame assembly; said alarm assembly having a sensor capable of sensing when a predetermined weight is on the seat and then said alarm assembly emits an audible and/or visible alarm if the predetermined weight remains on the seat for a predetermined length of time.

8. A portable commode as disclosed in claim 7 further characterized in that said frame assembly is collapsible by folding said legs together and folding said armrests against the frame assembly.

9. A portable commode as disclosed in claim 7 further characterized in that each of said legs terminate on the lower, ground contacting end in a wheel.

10. A portable commode as disclosed in claim 7 further characterized in that said receptacle is used with a disposable liner that has an integral zipper closure means and contains a liquid absorbing means.

11. A portable commode as disclosed in claim 7 further characterized in that said receptacle has a removable bottom so that the portable commode could be placed over a conventional toilet so that material passed into the receptacle may fall into the conventional toilet.
